(19) United States
(12) Patent Application Publication
(10) Pub. No.: US 2023/0043401 A1
(43) Pub. Date: Feb. 9, 2023

(54) INFORMATION COMMUNICATION SYSTEM AND METHOD FOR CONTROLLING TERMINAL

(71) Applicant: Panasonic Intellectual Property Management Co., Ltd., Osaka (JP)

(72) Inventor: Hiroki ITO, Osaka (JP)

(21) Appl. No.: 17/973,787

(22) Filed: Oct. 26, 2022

Related U.S. Application Data
(63) Continuation of application No. PCT/JP2020/018849, filed on May 11, 2020.

(51) Int. Cl. G06F 40/58; G10L 15/22; G10L 15/30; G06F 40/20; H05B 47/105; B64D 11/00

(52) U.S. Cl. CPC G06F 40/58; G10L 15/22; G10L 15/30; G06F 40/20; H05B 47/105; B64D 11/00155

(57) ABSTRACT

An in-flight announcement system (500) includes a voice input device (300) that inputs voice, a central control device (100) that translates an announcement content based on the input voice and outputs a modulation signal, a lighting device (400) that emits light based on the input modulation signal, and a receiving terminal (200) that specifies the announcement content based on an input light signal and outputs a translation result. The central control device (100) includes a recognition unit (101) that recognizes the voice information as utterance information, a determination unit (102) that determines whether the utterance information is a fixed sentence or not and outputs identification information of the fixed sentence, a text information group (103) including text information necessary for the determination unit (102) to determine and obtain the identification information, a translation unit (104) that translates the utterance information that is not determined as the fixed sentence and outputs reference information for the translation result, a storage (105) for storing the translation result, a generation unit (106) that generates a data set, a conversion unit (107) that generates the modulation signal based on the data set, and a moving body information management unit (108) that stores various information of an aircraft.

### TECHNICAL FIELD

The present disclosure relates to a voice information conversion device that outputs information corresponding to an uttered content under the condition where utterance contents to be input are predetermined (e.g., an announcement system that translates announcement of a fixed sentence and outputs the result).

### BACKGROUND ART

Patent Citation 1 discloses an announcement system that can provide translation of an uttered fixed announcement without delay. The announcement system includes a sound pickup device that inputs voice indicating a fixed sentence, a conversion device that generates translation the fixed sentence based on the input voice, and an output device that presents the translation. The conversion device includes a storage unit that stores first information indicating a predetermined sentence and second information indicating contents of the predetermined sentence in a different manner from the first information, a voice input unit that inputs voice information indicating the fixed sentence, a voice recognition unit that generates text information based on the voice information, a conversion process unit that specifies the first information corresponding to the fixed sentence based on the text information and a part of the first information before completing the input of the voice information of the entire fixed sentence, and a transmitting unit that transmits to the output device the second information corresponding to the specified first information. The output device presents the received second information. In this way, the corresponding fixed sentence is specified and translated before completing the input of the voice information, and hence translation corresponding to the uttered fixed announcement can be presented without delay.

### SUMMARY

Supposing that a voice information conversion device, which translates a voice information in a certain language into that in another language so as to present the result to a user, is mounted in a moving body such as an aircraft and is used for communication between an attendant and a passenger, there is a problem as described below.

One problem in such type of usage is how to communicate the translation result to the user. Currently, a personal monitor, which enables to enjoy movies or games, or to check flight status, is available widely at each seat of an aircraft, but in low-cost carriers (LCCs) that have been increasing recent years, a terminal for each passenger to obtain information is not usually provided. In this situation, it is considered good that the translation result is output as text information or voice to a passenger's own portable terminal such as a smartphone or a tablet. The widely used means for transmitting information to the portable terminal are methods using radio waves such as Bluetooth or wireless LAN standardized in IEEE802 or the like. However, particularly in an aircraft, there is a large restriction in information communication using radio waves. For instance, during the time before and after departure or landing of an aircraft, passengers are usually prohibited from using radio wave in order to avoid its influence to communication equipment related to aircraft operation. In addition, passengers are seated tightly and closely to each other in an aircraft, and it is difficult to assign the passengers with communication channels independent of each other.

For the reasons described above, it is considered difficult to transmit the translation result to the user's portable terminal using radio wave in the moving body.

Therefore, it is considered to use visual light communication as the communication means. The visual light communication is performed by blinking light or changing intensity of light, and hence it does not disturb the radio wave communication of the communication equipment related to aircraft operation, or does not affect operations of electronic equipment. In addition, lighting using LEDs, which is widely available recent years, can be used as transmitting equipment relatively easily. It is safe with little influence to human body.

However, in order to increase information quantity communicable per unit time, the visual light communication requires much cost. It is because expensive special equipment is necessary for both transmitter and receiver in order to perform communication of the same information quantity as the wireless LAN or Bluetooth described above.

For instance, as communication means for the visual light communication that can be realized relatively easily at the present time, a communication method is considered in which a general LED lighting is used as a transmitter while a camera image sensor embedded in a portable terminal such as a mobile phone is used as a receiver. In this case, information quantity communicable per unit time depends on an exposure speed of a receiver side image sensor. In order to realize a receiver side reading speed that does not disturb communication (e.g. less than 1 second), judging from the performance of the camera of the portable terminal that is widely available and the performance of the OS for controlling the same, what can be currently realized is to send a few tens of bits of information at one time from one side. This is too little information quantity to communicate conversation content as it is in communication between an attendant and a passenger.

The present disclosure provides an information communication system and a method for controlling a terminal, which uses visual light instead of radio wave whose use is restricted in a moving body, so as to transmit information correctly with a little information quantity, and to provide in-flight announcement to portable terminals of passengers of various nationalities in their mother tongues.

An information communication system according to the present disclosure is used in a moving body, and it includes a voice input unit, a recognition unit, an information group, a determination unit, a translation unit, a moving body information management unit, a generation unit, a conversion unit, and a light emission unit. The voice input unit inputs voice information in a first language. The recognition unit recognizes the voice information input from the voice input unit as utterance information. The information group includes a plurality of the utterance information as records. The determination unit searches the information group for a record corresponding to the utterance information recognized by the recognition unit and outputs record identification information for specifying the record. When the determination unit cannot specify the corresponding record in the information group, the translation unit translates the utterance information into translation information expressed in at least one language different from the first language, stores the translation information in a storage, and outputs reference information for access to the translation information. The moving body information management unit stores operation information of the moving body. The generation unit generates a data set from the operation information stored in the moving body information management unit and the record identification information or the reference information. The conversion unit generates a modulation signal based on the data set generated by the generation unit. The light emission unit emits light based on the modulation signal generated by the conversion unit.

A method for controlling a terminal according to the present disclosure is a method for controlling a terminal equipped with radio communication means, and the method includes a light receiving step in which a light receiving unit of the terminal receives a light beam on which a signal is superimposed, a restoring step for decoding the signal from the light beam received in the light receiving step, a determining step for determining whether or not to obtain information via the radio communication means, using the signal decoded in the restoring step, a first information generation step in which, if it is determined not to obtain information via the radio communication means in the determining step, an output unit that presents information to a user generates the information to be presented to the user using text data stored in the terminal in advance, and a second information generation step in which, if it is determined to obtain information via the radio communication means in the determining step, the output unit generates the information to be presented to the user using the information obtained via the radio communication means.

The information communication system and the method for controlling a terminal according to the present disclosure can translate utterance information and output the result as a few tens of bits of data set, and hence can provide in-flight announcement to portable terminals of passengers of various nationalities in their mother tongues, using visual light communication without use restriction.

### BRIEF DESCRIPTION OF DRAWINGS

FIG. 1 is a block diagram illustrating an internal structure of an in-flight announcement system.

FIG. 2 is a diagram illustrating a structural example of a text information group.

FIG. 3 is a diagram illustrating a structural example of a data set.

FIG. 4 is a diagram illustrating an example of aircraft operation information.

FIG. 5 is a diagram illustrating a structural example of a translation text information group.

FIG. 6 is a flowchart illustrating a process of a central control device.

FIG. 7 is a flowchart illustrating a process of a receiving terminal.

### DESCRIPTION OF EMBODIMENTS

Hereinafter, embodiments are described in detail with reference to the drawings appropriately. However, unnecessarily detailed description may be omitted. For instance, detailed description of well-known matters or overlapping description of the substantially same structure may be omitted. This is for avoiding unnecessarily redundant description and for a person skilled in the art to easily understand.

Note that the attached drawings and the following description are given for a person skilled in the art to sufficiently understand the present disclosure, but is not intended to limit the subject matter recited in the claims.

### EMBODIMENT 1

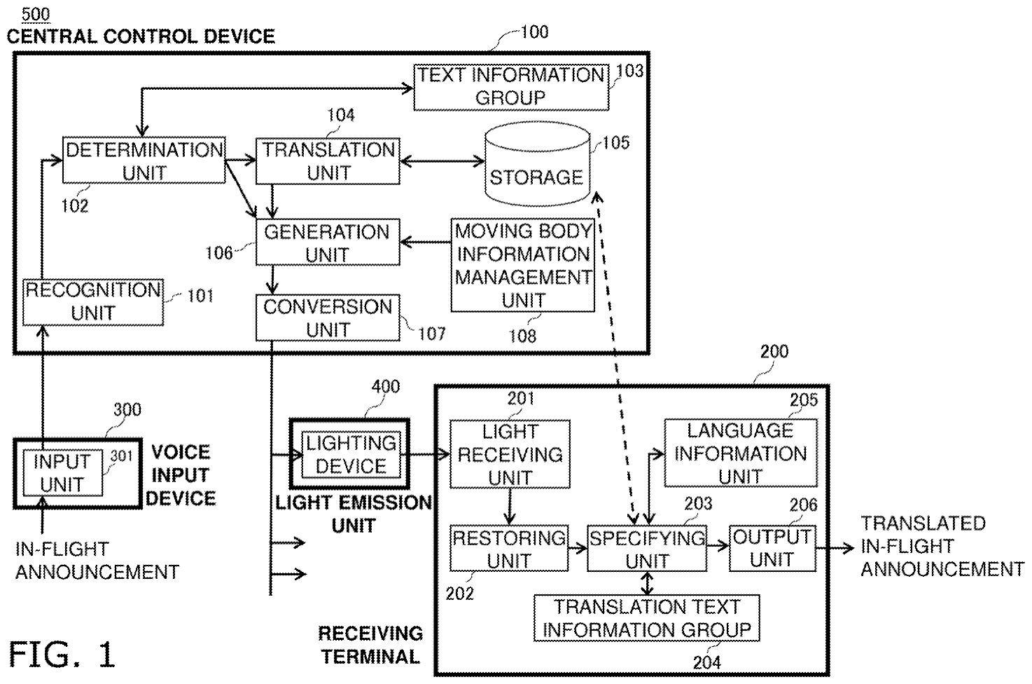

Hereinafter, Embodiment 1 is described with reference to FIGS. 1 to 4.

### 1-1. Structure

FIG. 1 is a block diagram illustrating a structure of an in-flight announcement system 500 according to an embodiment of the present disclosure.

### 1-1-1. Structure of Central Control Device

As illustrated in FIG. 1, a central control device 100 includes a recognition unit 101 that recognizes voice information as utterance information, a determination unit 102 that determines whether the utterance information is a fixed sentence or not, a text information group 103 including text information necessary for the determination unit 102 to determine, a translation unit 104 that translates the utterance information, a storage 105 for storing the translation content, a generation unit 106 that generates a data set, a conversion unit 107 that generates a modulation signal based on the data set, and a moving body information management unit 108 that stores various information of an aircraft.

The recognition unit 101 is realized when for example a CPU in the central control device 100 mainly executes software for recognizing input voice information as utterance information. Here, “recognizing—as utterance information” means to interpret meaning or content of the voice information using computer software or the like. The meaning or content obtained by this interpretation is the “utterance information”. For instance, the recognition unit 101 can be constituted of voice to text conversion software, morphological analysis software, and the like.

The determination unit 102 is realized when for example the CPU in the central control device 100 mainly executes a processing program, which includes comparing the input utterance information with the text information group 103, and outputting identification information of text information whose content is identical to that of the utterance information, or outputting the utterance information (non-fixed announcement) to the translation unit 104 if the text information having identical content is not found.

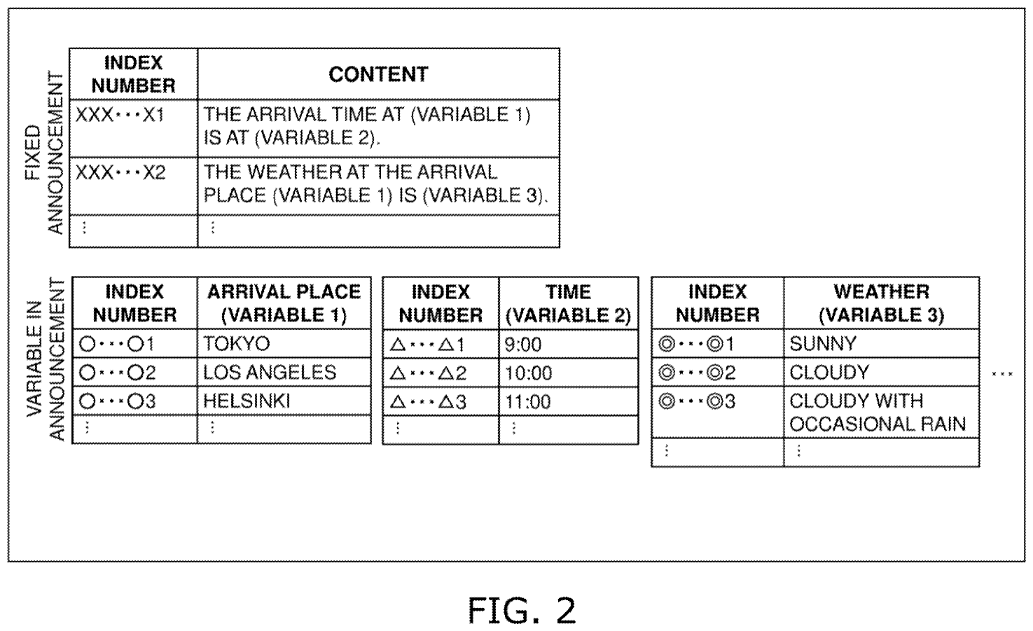

As illustrated in FIG. 2, the text information group 103 is a database including a plurality of records each of which includes an index number and a content for each of fixed announcement and variable in the announcement, and it is stored in a storage that can be accessed by the CPU in the central control device 100. This storage may be equivalent to or the same as the storage 105 described later.

The translation unit 104 is realized when for example the CPU in the central control device 100 mainly executes a processing program, which includes translating the input utterance information into different language, storing the result in the storage 105, and outputting reference information for access to the storage destination.

The storage 105 is a recording medium for storing the translation content, and can be constituted of a hard disk drive (HDD), a solid state drive (SSD), an optical disc drive, or the like, for example.

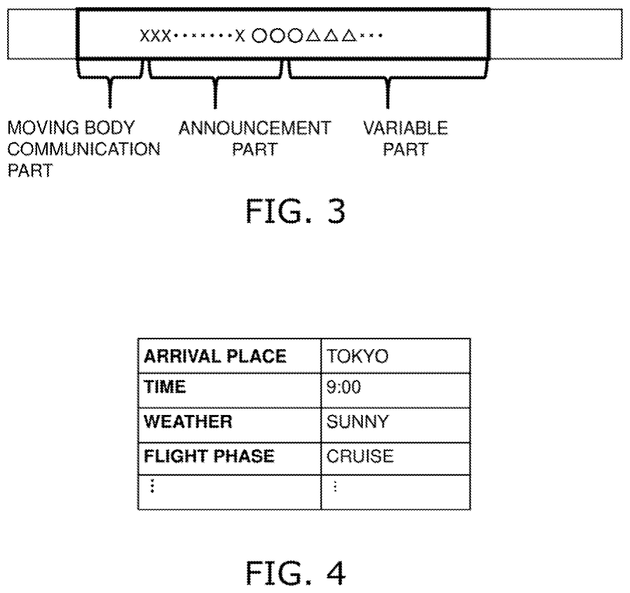

The generation unit 106 is realized when for example the CPU in the central control device 100 mainly executes a processing program for generating a data set based on the identification information from the determination unit 102 or the reference information from the translation unit 104, and operation information from the moving body information management unit 108. As illustrated in FIG. 3, the data set is constituted of a moving body communication part, an announcement part, and a variable part. The moving body communication part is a flag indicating whether or not radio communication can be performed in the aircraft, the announcement part is the index number of the fixed announcement or the reference information for the non-fixed announcement translation content, and the variable part is the index number of the variable in the announcement. The total size of the data set is a few tens of bits.

The conversion unit 107 is a modulation circuit that generates a modulation signal based on the data set, and outputs the same continuously for a certain period of time.

As illustrated in FIG. 4, the moving body information management unit 108 is a database that stores aircraft operation information necessary for processes in the determination unit 102 and the generation unit 106. Here, the operation information is information necessary for managing operation status of a moving body such as the aircraft or providing service to passengers, and it includes, for example, information about the departure place, information about the destination place, a flight phase, hardware information of the airframe, information about operational status of in-flight equipment, in-flight environment information, personal information of passengers, and the like, which are constantly updated. The operation information is stored in the storage that can be accessed by the CPU in the central control device 100, and this storage may be equivalent to or the same as the storage 105. The flight phase indicates the operational status of the aircraft such as ground run, takeoff, ascent, cruise, descent, or landing, and it further includes information about presence or absence of service by flight attendants during cruise, such as in-flight sales, drink service, meal service, or sleeping.

### 1-1-2. Structure of Receiving Terminal

As illustrated in FIG. 1, a receiving terminal 200 is a mobile information terminal, which includes a light receiving unit 201 that outputs input light as a modulation signal, a restoring unit 202 that restores the data set from the modulation signal, a specifying unit 203 that specifies in-flight announcement content based on content of the data set and outputs a translation result, a translation text information group 204 for storing text information necessary for the specifying unit 203 to specify the announcement content, a language information unit 205 that records a language of a user, and an output unit 206 that outputs the translation result, and it can be constituted of, for example, a smartphone, a tablet, a laptop computer, or the like.

The light receiving unit 201 includes a light receiving element for receiving light and an electric circuit for converting light into an electric signal, and it can be constituted of, for example, a small camera or the like embedded in the mobile information terminal.

The restoring unit 202 is a demodulation circuit that restores the same data set as that generated by the generation unit 106, on the basis of a modulation signal superimposed on a light beam received by the light receiving unit 201, and outputs the same.

The specifying unit 203 is realized when for example the CPU in the receiving terminal 200 mainly executes a. processing program, which includes determining whether or not to obtain the translation content from the storage 105 based on information stored in the moving body information management unit in the data set, specifying the announcement content based on the translation text information group 204 and the announcement part in the variable part of the data set, translating based on translation language information in the language information unit 205, and outputting the translation content.

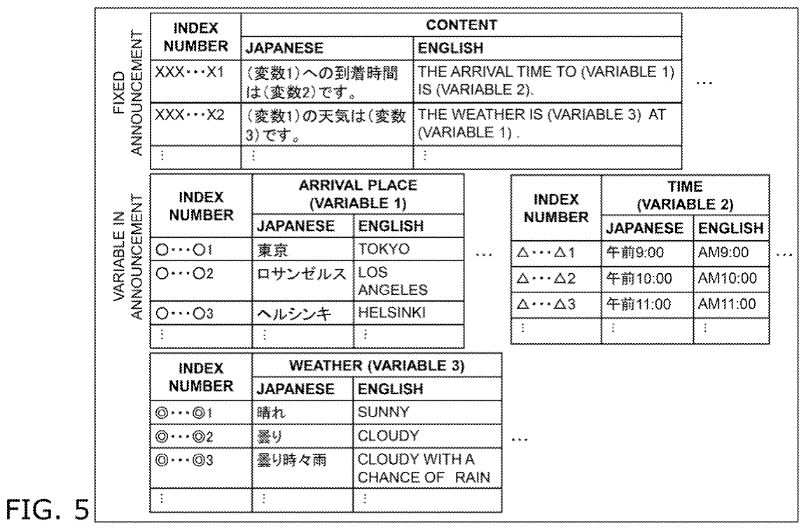

As illustrated in FIG. 5, the translation text information group 204 is a database group in which the same content as the text information group 103 is expressed in a plurality of languages, and it is stored in the storage that can be accessed by the CPU in the receiving terminal 200. This storage can be constituted of, for example, a hard disk drive (HDD), a solid state drive (SSD), an optical disc drive, or the like.

The language information unit 205 is an information source from which a language can be obtained that the owner of the receiving terminal 200 can understand, and it can be constituted of, for example, language setting information of the receiving terminal 200, language information selected by the owner with the input device, language information specified from the owner's voice, or the like.

The output unit 206 is an output interface for outputting the translation result of the in-flight announcement, which may be output as a text, an image, voice, or the like, and it can be constituted of, for example, a liquid crystal display, an organic EL display, a speaker, a headphone, a earphone, or the like.

### 1-1-3. Structure of Voice Input Device

As illustrated in FIG. 1, a voice input device 300 is a sound pickup device including an input unit 301 for inputting the in-flight announcement by a flight attendant as voice information, and it can be constituted of, for example, an in-flight communication handset, a pin microphone, a smartphone, or the like. The input unit 301 is a microphone, for example.

### 1-1-4. Structure of Lighting Device

As illustrated in FIG. 1, a lighting device 400 is lighting equipment including a light emission unit 401 that emits light based on the modulation signal, and it can be constituted of, for example, a reading light, in-flight overall lighting, or the like.

The light emission unit 401 is an optical element that converts a modulated electric signal into a light signal so as to emit a light beam on which a signal is superimposed, and it can be constituted of, for example, a light emitting diode (LED) or the like.

### 1-2. Operations

Operations of the central control device 100 and the receiving terminal 200 configured as below are described below.

### 1-2-1. Process of Central Control Device

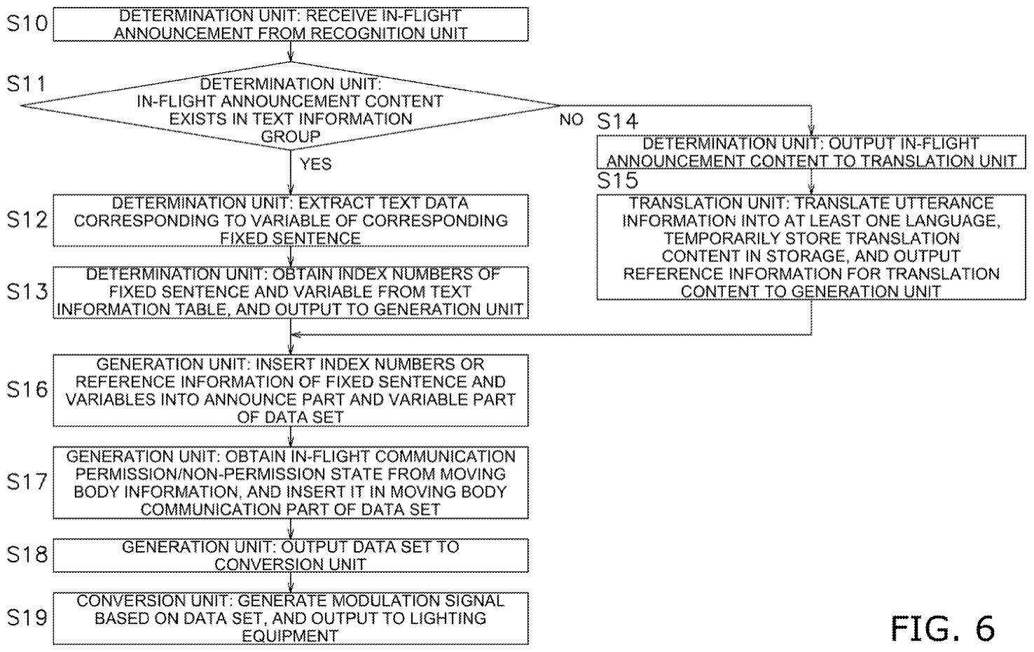

FIG. 6 is a flowchart illustrating a process of the central control device 100.

The in-flight announcement is input as a. voice signal to the recognition unit 101, which performs the voice recognition and outputs the result as text data to the determination unit 102 (S10).

The determination unit 102 determines whether or not the text information group 103 has text data (hereinafter referred to as registration text data) corresponding to text data that is input (hereinafter referred to as input text data) (S11). Here, when determining whether or not the text information group 103 has the corresponding text data, it is not always necessary to search for completely identical one. It is sufficient to retrieve text data having high relevance. Specifically, calculate similarity between the input text data and each registration text data in the text information group 103, determine whether or not there are registration text data having similarity higher than a threshold value, and identify the corresponding text data having the highest similarity among them. For instance, as the similarity determination, it is possible to determine the number of overlapping words, or to use similarity determination by machine learning, or the like.

If there are registration text data having similarity higher than the threshold value (Yes in S11), the determination unit 102 extracts text data (hereinafter referred to as extracted text data) corresponding to the variable of the registration text data (fixed announcement) from the input text data (S12). For instance, supposing that the input text data is “The arrival time at Tokyo is at 10:00.”, the corresponding registration text data is “The arrival time at (variable 1) is at (variable 2).”, and hence “Tokyo” corresponding to variable 1 and “10:00” corresponding to variable 2 are extracted.

The determination unit 102 obtains the index numbers of the extracted text data corresponding to the registration text data and the variables from the database in the text information group 103, and outputs the same to the generation unit 106 (S13). For instance, in the case of the text information group illustrated in FIG. 2, “XXX . . . X1” corresponding to “The arrival time at (variable 1) is at (variable 2).” of the registration text data, and “○ . . . ○” and “Δ . . . Δ2” corresponding to “Tokyo” and “10:00” of the extracted text data are obtained.

If there is no registration text data having similarity higher than the threshold value (No in S11), the determination unit 102 outputs the input text data to the translation unit 104 (S14).

The translation unit 104 performs a translation process on the input text data, stores the result in the storage 105, and outputs an address (reference information) of the storage destination to the generation unit 106 (S15).

The generation unit 106 divides and inserts the input index number or address into the announcement part and the variable part in the data set illustrated in FIG. 3 (S16). Specifically, the index number (registration index number) or address of the registration text data is inserted in the announcement part, and the index number (extracted index number) of the extracted text data is inserted in the variable part.

The generation unit 106 determines whether or not in-flight radio communication can be performed based on information stored in the moving body information management unit 108, and inserts the determination result in the moving body communication part of the data set (S17). For instance, it is determined that the radio communication can be performed if the flight phase in the moving body information management unit 108 is “cruise”, and that the radio communication cannot be performed if the flight phase is “ascent”.

Here, the method of using the flight phase is described above as the method for determining whether or not the in-flight radio communication can be performed based on the information stored in the moving body information management unit 108, but it may be possible to use other information to determine. For instance, it may be possible to use a distance from the departure place or the arrival place, elapsed time from takeoff, or a flight altitude for determination, or to directly obtain operation states of in-flight radio equipment for determination. In addition, it may be possible to determine whether or not to permit radio communication based on the personal information of the passenger sitting on the seat. In addition, even in the case where the flight phase is used, it may be possible to associate a phase other than “cruise” or “ascent” with permission or non-permission of radio communication.

The generation unit 106 outputs the completed data set to the conversion unit 107 (S18).

The conversion unit 107 determines a light blinking pattern based on the input data set, converts the blinking pattern into an electric signal (modulation signal) to be supplied to each lighting control device, and outputs the same to each lighting device 400 (S19).

### 1-2-2. Process of Receiving Terminal

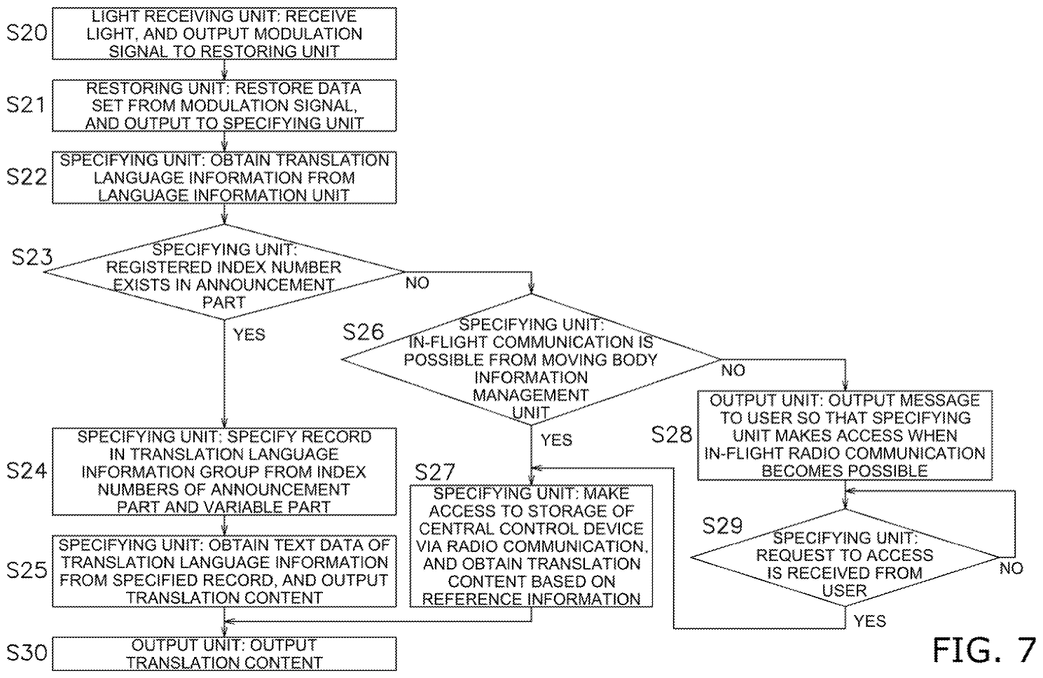

FIG. 7 is a flowchart illustrating a process of the receiving terminal 200.

The light receiving unit 201 converts the input light signal into an electric signal (modulation signal), and outputs the same to the restoring unit 202 (S20).

The restoring unit 202 restores the same data set as that generated by the generation unit 106 from the input electric signal, and outputs the same to the specifying unit 203 (S21).

The specifying unit 203 obtains translation target language information from the language information unit 205 (S22). The specifying unit 203 determines whether or not the registration index number exists in the announcement part of the data set input in S21 (S23). If the registration index number exists (Yes in S23), the specifying unit 203 retrieves the registration index number and the extracted index number stored in the variable part of the data set from the database of the translation text information group 204, and specifies the corresponding record (S24). The specifying unit 203 obtains the translation content corresponding to the language information obtained in S22 among the specified records, and outputs the translation result to the output unit 206 (S25).

If the registration index number does not exists (No in S23), the specifying unit 203 determines whether or not in-flight radio communication can be performed based on the determination result stored in the moving body communication part of the data set illustrated in FIG. 3 (S26). If the in-flight radio communication can be performed (Yes in S26), the specifying unit 203 makes access to the storage 105 of the central control device 100 based on the address (reference information) output in S15 of FIG. 6, which is in the announcement part of the data set, obtains the translation content corresponding to the translation language information, and outputs the translation result to the output unit 206 (S27). If the in-flight radio communication cannot be performed (No in S26), the output unit 206 outputs a message to the user so that the specifying unit 203 makes access to the storage 105 of the central control device 100 when the in-flight radio communication becomes possible (S28). This message is stored in the receiving terminal 200 in advance.

The specifying unit 203 waits for a request to access from the user, and performs the process S27 when receiving the request to access (529).

The output unit 206 outputs the input translation result to the user (S30).

### 1-3. Effects

As described above, the in-flight announcement system 500 of this embodiment is a system that translates an announcement uttered in a first language into one or more languages different from the first language, and transmits the translation result using visual light communication without use restriction in an aircraft or the like. In addition, the input utterance information is converted into identification information and reference information by the determination unit 102 and the translation unit 104, which are output as a data set by the generation unit 106.

With the structure and operation described above, the utterance information having a large information quantity can be compressed to information quantity of a few tens of bits. In this way, using visual light communication without use restriction, it is possible to provide in-flight announcement to portable terminals of passengers of various nationalities in their mother tongues.

### OTHER EMBODIMENT

As described above, the embodiment is described as an example of the technique disclosed in this application. However, the technique in the present disclosure is not limited to this, but can also be applied to embodiments in which appropriate modification, replacement, adding, eliminating, or the like is performed. In addition, it is also possible to combine the structural elements described above in the embodiments to make a new embodiment.

In the embodiments described above, the in-flight announcement system 500 is used in an aircraft as an example, but this is not a limitation. It may be installed in other vehicle such as a train, a bus, or a ship, or in a facility.

The circuit that performs processes of functional blocks of the in-flight announcement system 500 may includes, instead of the CPU, a processor constituted of a dedicated electronic circuit designed to perform a predetermined function. The processor can be realized in various types of processors such as a CPU, an MPU, a GPU, a DSP, a FPGA, and an ASIC. The processor may be constituted of one or more processors.

A computer readable recording medium that records a program for performing the processes of the functional blocks of the in-flight announcement system 500 is included in the scope of the present disclosure. Here, as the computer readable recording medium, there are, for example, a flexible disc, a hard disk, a CD-ROM, an MO, a DVD, a DVD-ROM, a DVD-RAM, a BD (Blu-ray Disc), and a semiconductor memory.

The computer program described above is not limited to the one recorded on the recording medium, but may be obtained via an electric communication line, a wireless or wired communication line, a network such as the Internet, or the like.

The execution order of the processes in the embodiment described above with reference to the flowchart is not always limited to the above description of the embodiment, but can be exchanged, or the processes may be executed simultaneously, without deviating from the spirit of the invention. The steps of the flowchart may be performed by one device, or may be shared and performed by a plurality of devices. Furthermore, if one step includes a plurality of processes, the plurality of processes included in the one step may be performed by one device, or may be shared and performed by a plurality of devices.

In the present disclosure, a system or a device means a set of structural elements (devices, modules (components), or the like), and it does not matter whether or not all structural elements are in the same casing. Therefore, a plurality of devices that are housed in different casings and are connected to each other via a network, and one device including a plurality of modules housed in one casing are both the system.

### INDUSTRIAL APPLICABILITY

The concept of the present disclosure is able to transmit information corresponding to uttered content using visual light, in a situation where radio wave communication is restricted. Therefore, the concept of the present disclosure can be widely applied to devices that output information corresponding to uttered content in a situation where radio wave communication is restricted. For instance, it is useful for an announcement system that translates and outputs announcement in an aircraft.

### REFERENCE SIGNS LIST

100 central control device

101 recognition unit

102 determination unit

103 text information group

104 translation unit

105 storage

106 generation unit

107 conversion unit

200 receiving terminal

201 light receiving unit

202 restoring unit

203 specifying unit

204 translation text information group

205 language information unit

206 output unit

300 voice input device

301 input unit

400 lighting device

500 in-flight announcement system

### PRIOR ART CITATIONS

### Patent Citation

Patent Citation 1: JP-A-2018-124323

1. An information communication system for a moving body, comprising:
a microphone for being input voice information in a first language;
a storage for storing an information group including a plurality of utterance information as records and operation information of the moving body;
a light emitter for emitting light; and
a controller for being configured to
recognize the voice information input from the microphone as utterance information; and
search the information group for a record in the storage corresponding to the utterance information recognized by the controller and output record identification information for specifying the record, wherein
when the controller cannot specify the corresponding record in the information group, the controller is further configured to:
translate the utterance information into translation information expressed in at least one language different from the first language;
store the translation information in the storage, and outputs reference information for access to the translation information;
generate a data set from the operation information and the record identification information or the reference information;
convert the data set into a modulation signal; and
emit light from the light emitter, based on the modulation signal.

2. The information communication system according to claim 1, wherein
the information group includes a database storing a plurality of records each of which includes text data and index information, and
the controller is configured to
extract a record having the highest relevance to the utterance information recognized by the controller from the information group, and
output information having the index information included in the record as the record identification information.

3. The information communication system according to claim 2, wherein
the text data includes a variable part,
the information group further includes a variable database storing a plurality of records each of which includes index information and data that can be stored in the variable part,
the controller is configured to extract a text corresponding to the variable part from the utterance information recognized by the controller,
output variable identification information including index information of a record corresponding to the text in the variable database, and
generate the data set from the operation information stored in the storage, the record identification information, and the variable identification information.

4. The information communication system according to claim 1, wherein
the moving body is a moving body having a plurality of seats, and
the light emitter is provided to each of the seats.

5. The information communication system according to claim 4, wherein the light emitter is the reading light provided corresponding to the seat.

6. The information communication system according to claim 1, wherein
the moving body is an aircraft having a plurality of seats, and
the operation information stored in the storage includes at least one of information about a departure place, information about an arrival place, a flight phase, hardware information of an airframe, information about operational status of in-flight equipment, in-flight environment information, and personal information of passengers.

7. The information communication system according to claim 1, wherein the controller determines whether or not radio communication can be performed in the moving body from the operation information stored in the moving body information management unit, and makes the data set include information about the determination result.

8. A method for controlling a terminal having radio communication system, the method comprising:
receiving a light beam in which a signal is superimposed;
decoding the signal from the light beam received; and
determining whether or not to obtain information via the radio communication system, using the signal decoded, wherein,
if it is determined not to obtain information via the radio communication system, an output unit that presents information to a user generates the information to be presented to the user using text data stored in the terminal in advance, and
if it is determined to obtain information via the radio communication system, the output unit generates the information to be presented to the user using the information obtained via the radio communication system.
